(19) United States
(12) Patent Application Publication
(10) Pub. No.: US 2013/0236601 A1
(43) Pub. Date: Sep. 12, 2013

(54) METHOD FOR REDUCING ACRYLAMIDE FORMATION IN MOLASSES POST-PRODUCTION

(71) Applicant: FRITO-LAY NORTH AMERICA, INC., Plano, TX (US)

(72) Inventors: Ellis COLLINS, Plano, TX (US); Vincent Allen ELDER, Carrollton, TX (US); David Brian EMERSON, Coppell, TX (US); Terry MOROS, Frisco, TX (US); Rayford Thomas SMITH, Rowlett, TX (US)

(73) Assignee: FRITO-LAY NORTH AMERICA, INC., Plano, TX (US)

(21) Appl. No.: 13/869,409

(22) Filed: Apr. 24, 2013

Related U.S. Application Data
(63) Continuation-in-part of application No. 11/624,496, filed on Jan. 18, 2007, now abandoned.
(60) Provisional application No. 61/679,313, filed on Aug. 3, 2012.

(51) Int. Cl. A23L 1/09

(52) U.S. Cl. CPC A23L 1/095
USPC 426/48; 426/262; 426/659

(57) ABSTRACT

Acrylamide reducing agents are added to molasses prior to heat treatment at temperatures above about 120° C. Preferably, citric acid is added to reduce the pH of the molasses, and asparaginase and/or lysine is added to the reduced pH molasses before it is heat treated at temperatures above about 120° C.

### CROSS-REFERENCE TO RELATED APPLICATION

This application claims the benefit of U.S. Provisional Application No. 61/679,313 entitled “Method for Reducing Acrylamide Formation in Molasses” filed Aug. 3, 2012, and this application is a continuation-in-part of co-pending U.S. application Ser. No. 11/624,496 entitled “Method for Reducing Acrylamide Formation” filed Jan. 18, 2007, the technical disclosures of which are hereby incorporated by reference in their entirety.

### BACKGROUND OF THE INVENTION

1. Technical Field

The present invention relates to a method for reducing the amount of acrylamide in the production and use of molasses, and permits the production of molasses and molasses-based coatings having significantly reduced levels of acrylamide. The invention more specifically relates to adding acrylamide-reducing agents, such as the enzyme asparaginase, food grade acids, and amino acids, to the molasses after it has been produced but before it undergoes further heat treatment.

2. Description of Related Art

The chemical acrylamide has long been used in its polymer form in industrial applications for water treatment, enhanced oil recovery, papermaking, flocculants, thickeners, ore processing and permanent press fabrics. Acrylamide participates as a white crystalline solid, is odorless, and is highly soluble in water (2155 g/L at 30° C.). Synonyms for acrylamide include 2-propenamide, ethylene carboxamide, acrylic acid amide, vinyl amide, and propenoic acid amide. Acrylamide has a molecular mass of 71.08, a melting point of 84.5° C., and a boiling point of 125° C. at 25 mmHg.

In very recent times, a wide variety of foods have tested positive for the presence of acrylamide monomer. Acrylamide has especially been found primarily in carbohydrate food products that have been heated or processed at high temperatures. Examples of foods that have tested positive for acrylamide include coffee, cereals, cookies, potato chips, crackers, french-fried potatoes, breads and rolls, and fried breaded meats. In general, relatively low contents of acrylamide have been found in heated protein-rich foods, while relatively high contents of acrylamide have been found in carbohydrate-rich foods, compared to non-detectable levels in unheated and boiled foods. Reported levels of acrylamide found in various similarly processed foods include a range of 330-2,300 (μg/kg) in potato chips, a range of 300-1100 (μg/kg) in french fries, a range 120-180 (μg/kg) in corn chips, and levels ranging from not detectable up to 1400 (μg/kg) in various breakfast cereals.

Acrylamide has not been determined to be detrimental to humans, but its presence in food products, especially at elevated levels, is undesirable. Therefore, it would be desirable to develop one or more methods of reducing the level of acrylamide in the end product of heated or thermally processed foods. Ideally, such a process should substantially reduce or eliminate the acrylamide in the end product without adversely affecting the quality and characteristics of the end product. Further, the method should be easy to implement and, preferably, add little or no cost to the overall process.

### SUMMARY OF THE INVENTION

In the inventive process of the instant application, at least one acrylamide reducing agent is added to the molasses prior to any further heat treatment and combination with other ingredients in a food product coating. Examples of acrylamide reducing agents include asparaginase, food grade acids (preferably citric acid) and amino acids (preferably lysine). The acrylamide reducing agents reduce the acrylamide formation in molasses when it is heat treated and combined with other ingredients to form a food product coating.

One embodiment of the invention is a method of reducing acrylamide formation during heat treatment of molasses, said method comprising the steps of: adding a food grade acid to said molasses until said molasses comprises a pH between 4.0 and 5.0; and heating said molasses after said adding steps to a temperature above about 120° C. The method may further comprise a pH after said adding step between 4.3 and 4.7.

In another embodiment, the method may further comprise, after said food grade acid is added, adding asparaginase or lysine to said molasses. The second adding step may add asparaginase or asparaginase and lysine.

In one embodiment of the invention, a food product coating comprises molasses made according to any combination of the method steps described above.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a block diagram of one method of producing molasses from sugar cane.

FIG. 2 is a block diagram of one method of refining raw sugar to produce other molasses grades.

### DETAILED DESCRIPTION

It is presently believed that acrylamide is formed from the presence of amino acids and reducing sugars. For example, it is believed that a reaction between free asparagine, an amino acid commonly found in raw vegetables, and free reducing sugars accounts for the majority of acrylamide found in fried food products.

The formation of acrylamide from amino acids other than asparagine is possible, but it has not yet been confirmed to any degree of certainty. For example, some acrylamide formation has been reported from testing glutamine, methionine, cysteine, and aspartic acid as precursors. These findings are difficult to confirm, however, due to potential asparagine impurities in stock amino acids. Nonetheless, asparagine has been identified as the amino acid precursor most responsible for the formation of acrylamide.

Since acrylamide in foods is a recently discovered phenomenon, its exact mechanism of formation has not been confirmed. However, it is now believed that the most likely route for acrylamide formation involves a Maillard reaction. The Maillard reactions have long been recognized in food chemistry as one of the most important chemical reactions in food processing and can affect flavor, color, and the nutritional value of the food. The Maillard reactions require heat, moisture, reducing sugars, and amino acids.

The Maillard reactions involve a series of complex reactions with numerous intermediates, but can be generally described as involving three steps. The first step of the Maillard reactions involve the combination of a free amino group (from free amino acids and/or proteins) with a reducing sugar (such as glucose) to form Amadori or Heyns rearrangement products. The second step involves degradation of the Amadori or Heyns rearrangement products via different alternative routes involving deoxyosones, fission, or Strecker degradation. A complex series of reactions—including dehydration, elimination, cyclization, fission, and fragmentation—results in a pool of flavor intermediates and flavor compounds. The third step of the Maillard reactions is characterized by the formation of brown nitrogenous polymers and co-polymers.

Again, asparagine is one of the amino acids that is believed to participate in the Maillard reactions, and is also believed to be a precursor in the formation of acrylamide. The enzyme asparaginase breaks asparagine down into aspartic acid and ammonia. Asparaginase, when added to food products that contain asparagine, has been found to decrease the amount of acrylamide formed because the reaction of asparaginase with asparagine can be initiated before the Maillard reaction takes place during food processing. Other acrylamide reducing agents that have been found to interfere with either the Maillard reaction generally, or with the conversion of asparagine specifically, include certain amino acids (such as lysine and cysteine), food grade acids (such as citric acid and phosphoric acid), divalent and trivalent cations (such as calcium chloride), and free thiols. Applicants have found that the addition of one or more acrylamide reducing agents to molasses after its production is both efficient and effective in reducing the amount of acrylamide formed during later heat treatment.

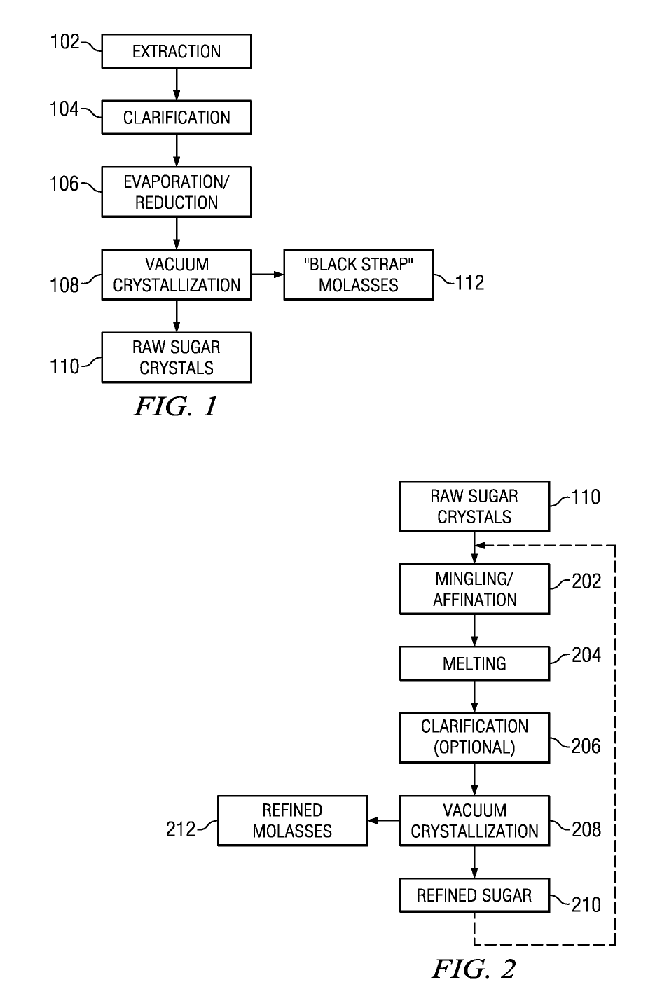

FIG. 1 is a block diagram that depicts the general processing steps of one method used to make molasses. The process begins with raw sugar cane juice, which is extracted from sugar cane. Although molasses can be made from other sugar sources, such as sugar beets, Applicants focus herein on the traditional and most widely-used process that starts with sugar cane juice. The sugar cane juice is extracted 102 from sugar cane by mashing, milling, crushing or otherwise comminuting sugar cane that has been stripped of its leaves. Water is added to the process to facilitate extraction of the juice.

The juice is then clarified 104 (filtered) and subjected to a number of evaporation/reduction steps 106 that boil the juice and concentrate it into a syrup. In the clarification step 104, juice is heated to about 95° C. to 100° C., and lime (or other food grade base) is added to raise the pH to about 6.5 to 7.5. The lime, colloidal and suspended solids, mud and bagasse particles settle out, resulting in a light colored, translucent solution. The evaporation step heats the resulting solution to temperatures above the boiling point of water, and produces a syrup of about 60-70 Brix. After a number of evaporation steps, sugar begins to crystallize in the syrup. The number of steps performed depends on a number of factors, including the temperature and pressure of the unit operations, and the moisture content of the sugar cane juice. The raw sugar crystals 110 are separated from the syrup in a vacuum crystallization step 108, and the remaining syrup is one variety of molasses 112. The crystallization step 108 is conducted under vacuum to enable lower temperatures to be used, which minimizes sucrose degradation.

FIG. 2 is a block diagram that depicts the general processing steps of one method used to refine the raw sugar 110 that is output from the process depicted in FIG. 1. Raw sugar crystals 110 are mixed with a “mother liquor” (which usually is a portion of the molasses separated from the raw sugar crystals in the previous process) in a mingling/affination step 202. In the mingling step 202, the mixture is sprayed with hot water (between 80° C. and 100° C.), and spun in a centrifuge to produce a syrup. The light fraction exiting the centrifuge is the sugar syrup that is further refined, and the heavy fraction is a waste stream comprising primarily inverted sugar, ash and undesirable organics. The mingled sugar syrup stream is then transferred to a melting (or dissolving) step 204. In the melting step, water is added to produce a “melt liquor” at 68-73 Brix. The melted mixture is then, optionally, clarified 206. The clarification step can involve, for example, mixing phosphoric acid and calcium hydroxide with the syrup, which combine to precipitate calcium phosphate. Calcium phosphate particles entrap or absorb some of the impurities. The clarification step can also involve filtering the syrup through activated carbon or bone char.

The final step in sugar refining is a vacuum crystallization step 208. This is typically a four stage process where the sugar mixture is mechanically stirred and boiled at low pressure and low temperature to reduce sucrose degradation. The output of this vacuum crystallization step is a refined sugar stream 210 and a molasses stream 212 which are lighter in color than the sugar and molasses output from the process depicted in FIG. 1. The refined sugar can be run through the process of FIG. 2 again to further refine it, and produce successive refined sugar and molasses streams which emerge lighter in color than those produced by the previous iteration.

The sugary plant material used to make the starting juice typically contains asparagine and reducing sugars, which means it has the potential to form acrylamide when heated. In fact, Applicants have measured commercially available molasses and found that some molasses does contain a significant amount of acrylamide. Interestingly, molasses also contains a significant amount of free asparagine and reducing sugars (and likely intermediates between asparagine and acrylamide), which means further heat treatment of the molasses will result in more acrylamide formation.

Commercially available molasses is sold in varieties of different color, ranging from light golden molasses to dark brown molasses, which is referred to in the United States colloquially as blackstrap molasses. The molasses produced by the process in FIG. 1 is generally the darkest in color, so-called “blackstrap” molasses. Applicants herein have found that generally, a molasses that is darker in color has a higher level of acrylamide. Applicants theorize, without being limited by theory, that (assuming the same or similar starting materials) darker molasses is formed from syrup that has been cooked at higher temperatures or for longer periods of time, at lower moisture content, than lighter molasses. Moreover, Applicants have found that there is a point during the molasses making process depicted in FIG. 1 at which asparagine begins rapidly converting into acrylamide. This point likely occurs during the multi-stage evaporation step 106 when the moisture content of the syrup drops low enough, and the temperature of the syrup rises high enough, that the Maillard reactions begin to form the brown products characteristic of the Maillard reactions.

Applicants have also determined that acrylamide can be formed during the sugar refining process depicted in FIG. 2. Because the temperature during the melting step 204 generally occurs at high temperature, most of the acrylamide formed during sugar refining likely occurs during this melting step.

The reaction between asparaginase and asparagine is most efficient at a temperature between about 110° F. and 120° F., and almost completely stops at temperatures higher than about 140° F. because the enzyme asparaginase begins to denature. Therefore, if asparaginase is added in close proximity to a high temperature step in the process, it will not be effective in reducing acrylamide formation because the high temperatures will denature the asparaginase.

Applicants have measured the level of asparagine and acrylamide in several commercially available sugar and molasses products. Four different types of brown (unrefined) sugar (turbinado, demerara, raw and muscovado) showed asparagine levels, on a dry basis, ranging from 11.38 ppm to 2,169.39 ppm, and acrylamide levels ranging from 12.41 ppb to 1,561.10 ppb. White (refined) sugar contained 1.9 ppm asparagine on a dry basis, and undetectable levels of acrylamide.

Molasses products varying from light color to dark color were obtained from two different manufacturers, and analyzed for asparagine and acrylamide content. The acrylamide content (dry basis) of the molasses varied from 269 ppm to 6101 ppm, and the asparagine level (dry basis) varied from 34 ppm to 1897 ppm.

Darker molasses generally has a higher level of acrylamide. However, the asparagine content is also generally higher in darker molasses, except for the darkest available molasses.

In some embodiments, different grades or fractions of molasses are combined to produce a hybrid molasses product that is used as an ingredient for a food product coating. In other embodiments, a single fraction of molasses is used. Applicants herein have determined that when acrylamide reducing agents are added to a single fraction or hybrid molasses after it is created, but before the molasses undergoes any further heat treatment, significant acrylamide reduction can be accomplished.

In a series of experiments, Applicants tested individual treatments and combinations of citric acid, asparaginase and lysine to reduce acrylamide formation in heat treated molasses. In each test, the acrylamide reducing agent or agents were added to the molasses and heated for two hours at about 60° C. to simulate normal molasses production processes. The control or treated molasses was then combined with other minor ingredients and heated to temperatures between about 135° C. and 150° C., as is typical in preparing molasses to be applied as a topical food product coating. Table 1 below shows the results of these experiments.

TABLE 1
Molasses Experimental Results

| | Acrylamide Level | % Acrylamide |
|---|---|---|
| Sample | (ppb) | Reduction vs. Control |
| Control | 793 | n/a |
| Heat Only | 788 | 1 |
| Citric Acid Only | 515 | 35 |
| Citric Acid + | 534 | 33 |
| Asparaginase | | |
| Citric Acid + | 414 | 48 |
| Asparaginase + Lysine | | |

Applicants herein also tested the acrylamide reduction effect of several different pH modifications of molasses using citric acid, the results of which are presented in Table 2 below.

TABLE 2
Effect of pH on Acrylamide Reduction

| | Acrylamide | % Acrylamide |
|---|---|---|
| Sample | level (ppb) | Reduction vs. Control |
| Control | 786 | n/a |
| Citric Acid (5.0 pH) | 648 | 17.6 |
| Citric Acid (4.5 pH) | 569 | 27.5 |
| Citric Acid (4.0 pH) | 391 | 50.2 |

Applicants herein also tested the effectiveness of citric acid as an acrylamide reducing agent over several different molasses lots to demonstrate repeatability. The results of these tests are presented in Table 3 below.

TABLE 3
Repeatability of Acrylamide Reduction Using Citric Acid

| | | Acrylamide level | % Acrylamide Reduction |
|---|---|---|---|
| Sample | Lot # | (ppb) | vs. Control |
| Control | A | 549 | n/a |
| Citric Acid (4.5 pH) | | 414 | 24.6 |
| Control | B | 849 | n/a |
| Citric Acid (4.5 pH) | | 602 | 29.1 |
| Control | C | 478 | n/a |
| Citric Acid (4.5 pH) | | 406 | 15.1 |
| Control | D | 786 | n/a |
| Citric Acid (4.5 pH) | | 533 | 32.2 |

Another set of experimental molasses lots was prepared using the following procedure: Citric acid was added to the molasses and mixed. pH was checked to verify that it fell between 4.3 and 4.7, with a target of 4.5. Next, an asparaginase enzyme with peak activity at a low pH range was added to the molasses and mixed for about 30 minutes. Control lots of molasses were also prepared without adding any of the ingredients above. The experimental and control molasses lots were then pasteurized at temperatures between about 140° F. and 170° F. The average values of acrylamide, asparagine, moisture percent and pH for the treated and untreated (control) lots are presented in Table 4 below.

TABLE 4
Reduced pH Molasses Experiments

| Molasses | Acrylamide | Asparagine | Moisture | |
|---|---|---|---|---|
| Type | (ppb) | (ppm) | (%) | pH |
| Treated | 2063 | 33.5 | 23.26 | 4.95 |
| Untreated | 2553 | 232.2 | 23.51 | 5.52 |

The treated and untreated molasses samples were then separately used as ingredients in a topical food coating. The coating was produced by combining molasses with sugar and other ingredients and heating the mixture above 120° C. to lower the moisture content and increase the Brix. The resulting coating was used to coat popcorn pieces, and the acrylamide level of the finished product was measured. The final coated product comprised about 5% molasses. When treated molasses was used, the acrylamide concentration of the food product averaged 339 ppb, and when untreated molasses was used the acrylamide concentration of the food product was 438 ppb. This represented about a 23% decrease in acrylamide formation between the coated popcorn made using untreated molasses and the coated popcorn made using treated molasses.

The importance of order of addition of ingredients and the combination effect of citric acid and enzyme were also verified by another set of experiments. Several experimental lots of molasses were made by adding citric acid only, enzyme only, citric acid followed by enzyme, and enzyme followed by citric acid. Table 5 below presents the results of these experiments in terms of percent reduction in acrylamide versus control.

TABLE 5
Acrylamide Reduction in Molasses

| | | % Acrylamide |
|---|---|---|
| | Acrylamide | Reduction |
| Sample | (ppb) | vs. Control |
| Control | 744 | — |
| Citric Acid Only | 484 | 39% |
| Enzyme Only | 640 | 19% |
| Citric Acid + Enzyme | 445 | 43% |
| Enzyme + Citric Acid | 551 | 30% |

As shown in Table 5, when asparaginase enzyme was added before citric acid, the reduction in acrylamide was not as efficient as when citric acid was added before enzyme, or when citric acid was used alone.

Based on the experimental results, in one embodiment of the present invention at least one of a food grade acid, an amino acid and asparaginase are added to molasses after said molasses is produced but before said molasses undergoes any heat treating at temperatures above about 120° C. In a preferred embodiment, a food grade acid, most preferably citric acid, is used to adjust the pH of the molasses to between 4.0 and 5.0 (most preferably about 4.5), prior to any heat treatment above about 120° C. In a more preferred embodiment, the pH of the molasses is adjusted to between 4.3 and 4.7 prior to any heat treatment above 120° C. It is preferred to use an asparaginase enzyme that exhibits high activity at the target pH levels identified herein, although any asparaginase enzyme that retains some activity at low pH will work with the present invention.

In a most preferred embodiment, when a food grade acid is used in combination with another acrylamide reducing agent, the food grade acid is used to adjust the pH of the molasses before any other acrylamide reducing agent is added to the molasses, which other acrylamide reducing agent should be added before any further heat treatment above 120° C. In other words, if citric acid is being used, preferably citric acid is added first in order to lower the pH before asparaginase is added to the molasses.

In one embodiment, the treated molasses is used as a food product coating or combined with other ingredients to form a food product coating. In a preferred embodiment, the treated molasses is combined with other ingredients and used to coat popcorn pieces.

The embodiments of the invention described above can be used individually, but can also be used in combination with each other or other methods of reducing acrylamide. The combination of embodiments can be utilized to further drive down the incidence of acrylamide in molasses from that attainable by single embodiments, or the combinations can be utilized to attain a low level of acrylamide without undue alterations in the taste and texture of the molasses.

While the invention has been particularly shown and described with reference to several embodiments, it will be understood by those skilled in the art that various other approaches to the reduction of acrylamide in thermally processed foods by use of asparaginase, food grade acids and amino acids may be made without departing from the spirit and scope of this invention.

What is claimed is:

1. A method of reducing acrylamide formation during heat treatment of molasses, said method comprising the steps of:
adding a food grade acid to said molasses until said molasses comprises a pH between 4.0 and 5.0; and
heating said molasses after said adding steps to a temperature above about 120° C.

2. The method of claim 1 wherein said pH after said adding step is between 4.3 and 4.7.

3. The method of claim 1 further comprising, after said food grade acid is added, adding asparaginase or lysine to said molasses.

4. The method of claim 3 wherein said second adding step adds asparaginase.

5. The method of claim 3 wherein said second adding step adds asparaginase and lysine.

6. A food product coating comprising molasses made according to the method of claim 1.
